(19) United States
(12) Patent Application Publication
(10) Pub. No.: US 2006/0206828 A1
(43) Pub. Date: Sep. 14, 2006

(54) Display device of a calculator capable of displaying a composite icon

(75) Inventors: Tien-Hsian Chang, Shenkeng Township (TW); Leng-Feng Kuo, Shenkeng Township (TW)

Correspondence Address: BACON & THOMAS, PLLC, 625 SLATERS LANE, FOURTH FLOOR, ALEXANDRIA, VA, 22314, US

(73) Assignee: Kinpo Electronics, Inc., Taipei (TW)

(21) Appl. No.: 11/076,953

(22) Filed: Mar. 11, 2005

(51) Int. Cl. G06F 9/00; G06F 17/00

(52) U.S. Cl. 715/764; 715/837; 715/835; 715/864

(57) ABSTRACT

The present invention provides a display device of a calculator capable of displaying a composite icon, which comprises of a display panel and a composite icon. The composite icon which is shown on the display panel comprises multiple symbols in which at least one symbol is required to compose an icon; multiple numbers of pins are for driving the multiple symbols and then selectively illuminating at least one symbol in displaying an icon.

### BACKGROUND OF THE INVENTION

1. Field of the Invention

The present invention relates to the field of calculators, and particularly to which its display device could exhibit a composite icon.

2. Description of Related Art

Because of the convenience and quick calculating result they provide, calculators have been broadly utilized in people's daily life, from basic addition/subtraction to complicated scientific algorithm. In order to satisfy these various tasks people expect out of a calculator, numerous types of built-in functions have to be programmed and shown on the display device for indicating their associated functions.

For example, accounting personnel who more likely would come across all kinds of tax-related calculations would look for calculators with built-in tax calculating function. For easy accessibility the calculator shall display ′TAX″ icon on its display device to clearly indicate to the user that the tax calculating function is currently being performed. As FIG. 1 shown, in general ′+TAX″, ′−TAX″, and ′TAX %″ icons can be found on the display device 10 of a calculator with tax-calculating function. When ′+TAX″ icon is shown on the display device, it implies that the calculator is performing a tax-addition calculating function. When ′−TAX″ icon is shown, it implies that the calculator is performing a tax-subtraction function. The same logic applies as ′TAX %″ icon which being shown indicates that the calculator is performing a percentage-tax calculating function.

In terms of constructing the display device 10, the ′+TAX″ icon is comprised of symbols ′+″ 11 and ′TAX″ 12; the ′−TAX″ icon is comprised of symbols ′−″ 13 and ′TAX″ 14; the ′TAX %″ icon is comprised of symbols ′TAX″ 15 and ′%″ 16. The symbols, ′+″ 11, ′TAX″ 12, ′−″ 13, ′TAX″ 14, ′TAX″ 15, and ′%″ 16, respectively connect to pins SI1, S12, S13, S14, S15, and S16 through the wire layout in order to be driven.

When the driving of pin S11 and S12 takes place, ′+TAX″ icon is illuminated. Also when pin S13 and S14 are driven, ′−TAX″ icon is then illuminated; same logic applies when pin S15 and S16 are driven, and ′TAX %″ icon is then illuminated. The above pattern reveals that the number of pins required in the display device 10 is directly proportional to the number of ′TAX″ icons being set up, and accordingly the more ′TAX″ icons are applied, more complicated the layout will be and more space it will be required, causing it quite difficult to downsize the display device 10. In addition, because of all three ′+TAX″, ′−TAX″, and ′TAX %″ icons are displayed separately among different locations on the display device 10, considerable amount of room on such device must be occupied by the icons with which many users may find confused in terms of correctly reading the icons.

### SUMMARY OF THE INVENTION

The present invention has been accomplished under the circumstances in view. It is therefore the main object of the present invention to provide a display device of a calculator capable of displaying a composite icon wherein it effectively reduces the number of pins required, significantly decreases the space occupied by the icons on the display device, and simplifies the complexity of the layout. Such composite icon can result in minimizing the size of the display device and showing clearly recognizable icon to users when each associated function is being performed.

To achieve this and other objects of the present invention, the display device comprises of a display panel, and acomposite icon. The composite icon which is shown on the display device comprises of multiple symbols in which at least one symbol is required to compose an icon; multiple pins are for driving the multiple numbers of symbols, respectively, and then selectively illuminating at least one symbol in displaying an icon.

### BRIEF DESCRIPTION OF THE DRAWINGS

FIG. 1 is an example of a prior art of which a calculator displaying ′TAX″ icons.

FIG. 2 is a better illustration of the preferred embodiment of the display device of a calculator displaying a composite icon.

FIG. 3 is a composite icon according to the present invention.

FIG. 4 is the first alteration of the icon according to the present invention.

FIG. 5 is the second alteration of the composite icon according to the present invention.

FIG. 6 is the third alteration of the composite icon according to the present invention.

FIG. 7 is the fourth alteration of the composite icon according to the present invention.

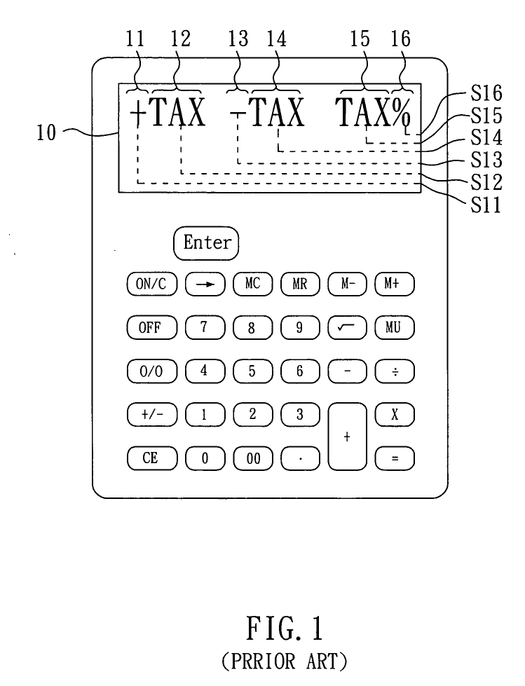

### DETAILED DESCRIPTION OF THE PREFERRED EMBODIMENT

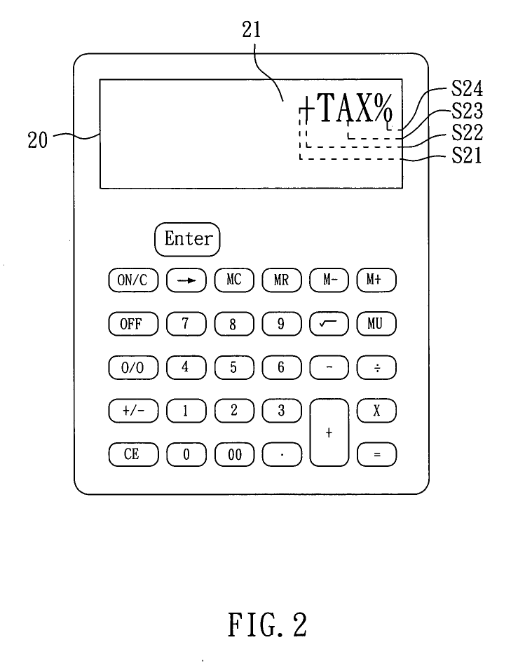

FIG. 2 shows the preferred embodiment of the display device of a calculator capable of displaying an composite icon of which it comprises a display panel 20, an composite ′+TAX %″ icon 21 shown on the display panel 20, and a plurality of pins S21, S22, S23, and S24 for driving the composite icon 21 thereof. A Liquid Crystal Display (LCD) is preferable for the display panel, and the pins S21, S22, S23, and S24 connect to the composite icon 21 thereof through the wire layout.

FIG. 3 further illustrates the above-mentioned composite icon 21 in terms of its structure, which comprises ′−″ symbol 32, ′|″ symbol 31, ′TAX″ symbol 33, and ′%″ symbol 34. These symbols, ′−″ 32, ′|″ 31, ′TAX″ 33, and ′%″ 34 connect to the pins S21, S22, S23, and S24 shown in FIG. 2 respectively. Therefore, the symbols ′−″ 32, ′|″ 31, ′TAX″ 33, and ′%″ 34 can be illuminated by driving the pins S21, S22, S23, and S24, respectively.

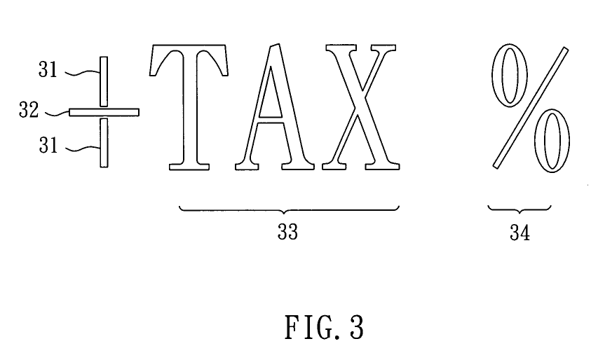

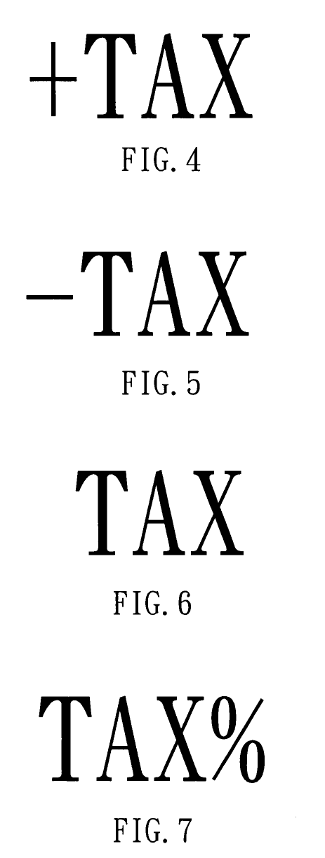

The above-mentioned setting of the composite icon 21 enables calculators with built-in tax calculating function to serve the purposes of displaying different alterations of the ′TAX″ icons. In detail when pins S21, S22, and S23 in FIG. 2 are simultaneously driven, symbols including ′|″ 31, ′−″ 32, and ′TAX″ 33 shall also be simultaneously illuminated; as a result a ′+TAX″ icon will be displayed on the display panel 20 as shown in FIG. 4. When pins S21 and S23 in FIG. 2 are driven simultaneously, symbols including ′−″ 32 and ′TAX″ 33 shall also be simultaneously illuminated; as a result a ′−TAX″ icon will be displayed on the display panel 20 as shown in FIG. 5. When pin S23 in FIG. 2 is driven, symbol ′TAX″ 33 shall be illuminated; as a result a ′TAX″ icon will be displayed on the display panel 20 as shown in FIG. 6. When pins S23 and S24 in FIG. 2 are driven simultaneously, symbols including ′TAX″ 33 and ′%″ 34 shall also be simultaneously illuminated; as a result a ′TAX %″ icon will be displayed on the display panel 20 as shown in FIG. 7.

In view of the foregoing, it is known that the present invention achieves in displaying all necessary TAX icons on the display device by utilization of a composite icon of a calculator's display device in which symbols are properly illuminated by driving certain pins. Furthermore, since the composite icon involves less numbers of symbols than the one of which it requires more than one ′TAX″ icons among different locations of the display panel, it effectively reduces the numbers of pins required to drive the composite icon, leading to a tremendous decrease in the spatial occupancy on the calculator's display device and level of complexity involved within the layout, and eventually minimizes the display device. Also the user can clearly identify which function the calculator is currently performing due to one single spot on which numerous alterations of TAX icons can display.

Although the present invention has been explained in relation to its preferred embodiment, it is to be understood that many other possible modifications and variations can be made without departing from the spirit and scope of the invention as hereinafter claimed.

What is claimed is:

1. A display device of a calculator capable of displaying a composite icon comprising:
a display panel;
a composite icon, consisting of multiple symbols in which at least one symbol composes an icon, and located on the display panel; and
multiple pins for driving the multiple symbols, respectively, and then selectively illuminating at least one symbol to display an icon.

2. The display device of a calculator capable of displaying composite icon as claimed in claiml, wherein multiple symbols include: ′−″, ′|″, ′TAX″, and ′%″.

3. The display device of a calculator capable of displaying composite icon as claimed in claim 2, wherein the multiple pins are provided for driving ′+″ symbol and ′TAX″ symbol to display the icon of ′+TAX″.

4. The display device of a calculator capable of displaying composite icon as claimed in claim 2, wherein the multiple pins f are provided for driving ′−″ symbol and ′TAX″ symbol to display the icon of ′−TAX″.

5. The display device of a calculator capable of displaying composite icon as claimed in claim 2, wherein the multiple pins are provided for driving ′TAX″ symbol to display the icon of ′TAX″.

6. The display device of a calculator capable of displaying composite icon as claimed in claim 2, wherein the multiple pins are provided for driving ′TAX″ symbol and ′%″ symbol to display the icon of ′TAX %″.

7. The display device of a calculator capable of displaying a composite icon as claimed in claim 2, wherein the display panel is a Liquid Crystal Display (LCD).
